(19) United States
(12) Patent Application Publication
(10) Pub. No.: US 2018/0297219 A1
(43) Pub. Date: Oct. 18, 2018

(54) Screen And Spline Replacement Tool

(71) Applicant: Ezequiel Gutierrez, Ontario, CA (US)

(72) Inventor: Ezequiel Gutierrez, Ontario, CA (US)

(21) Appl. No.: 16/011,316

(22) Filed: Jun. 18, 2018

Related U.S. Application Data
(63) Continuation-in-part of application No. 13/953,939, filed on Jul. 30, 2013, now abandoned.
Application No. 13/953,939 is a continuation-in-part of application No. 13/669,188, filed on Nov. 5, 2012, now abandoned.

(51) Int. Cl. B26B 5/00

(52) U.S. Cl. CPC B26B 5/003; B26B 29/02; B26B 5/008

(57) ABSTRACT

A screen and spline replacement tool includes an elongated housing that has a first end, a second end and a peripheral wall extending between the first end and the second end and defining an interior space. The peripheral wall includes an upper wall, a lower wall, a first lateral wall and a second lateral wall. A blade, including a sharpened edge, is coupled to the housing. The blade is selectively extendable from the interior of the housing through the first end of the housing. A wheel is rotatably coupled to the housing. The wheel has an outer perimeter edge extending from the second end of the housing and the outer perimeter edge is used for urging screen spline into a channel.

This application is a continuation in part of U.S. patent application Ser. No. 13/953,939 filed on Jul. 7, 2013, which claims benefit under 35 U.S.C. Section 120 of U.S. patent application Ser. No. 13/669,188 filed Nov. 5, 2012.

### BACKGROUND OF THE DISCLOSURE

### Field of the Disclosure

The disclosure relates to screen and spline removal and replacement devices and more particularly pertains to a new screen and spline replacement tool for assisting a person when installing a replacement widow screen.

### SUMMARY OF THE DISCLOSURE

An embodiment of the disclosure meets the needs presented above by generally comprising an elongated housing that has a first end, a second end and a peripheral wall extending between the first end and the second end and defining an interior space. The peripheral wall includes an upper wall, a lower wall, a first lateral wall and a second lateral wall. A blade, including a sharpened edge, is coupled to the housing. The blade is selectively extendable from the interior of the housing through the first end of the housing. A wheel is rotatably coupled to the housing. The wheel has an outer perimeter edge extending from the second end of the housing and the outer perimeter edge is used for urging screen spline into a channel. A first actuator is operationally coupled to the blade for selectively extending the blade. The first actuator is positioned on the upper wall of the housing and is positioned in a first slot in the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a screen and spline replacement tool according to an embodiment of the disclosure.

FIG. 2 is a top view of an embodiment of the disclosure.

FIG. 3 is a right side view of an embodiment of the disclosure.

FIG. 4 is a cross-sectional view of an embodiment of the disclosure taken along line 4-4 of FIG. 2.

FIG. 5 is a cross-sectional view of an embodiment of the disclosure taken along line 5-5 of FIG. 2.

FIG. 6 is a cross-sectional view of an embodiment of the disclosure taken along line 6-6 of FIG. 2.

FIG. 7 is a cross-sectional view of an embodiment of the disclosure taken along line 7-7 of FIG. 3.

FIG. 8 is a perspective in-use view of an embodiment of the disclosure.

FIG. 9 is a cross-sectional view of an embodiment of the disclosure similar to FIG. 5 disclosing an alternative tool insert.

FIG. 10 is a cross-sectional view of an embodiment of the disclosure similar to FIG. 5 disclosing another alternative tool insert.

### DESCRIPTION OF THE PREFERRED EMBODIMENT

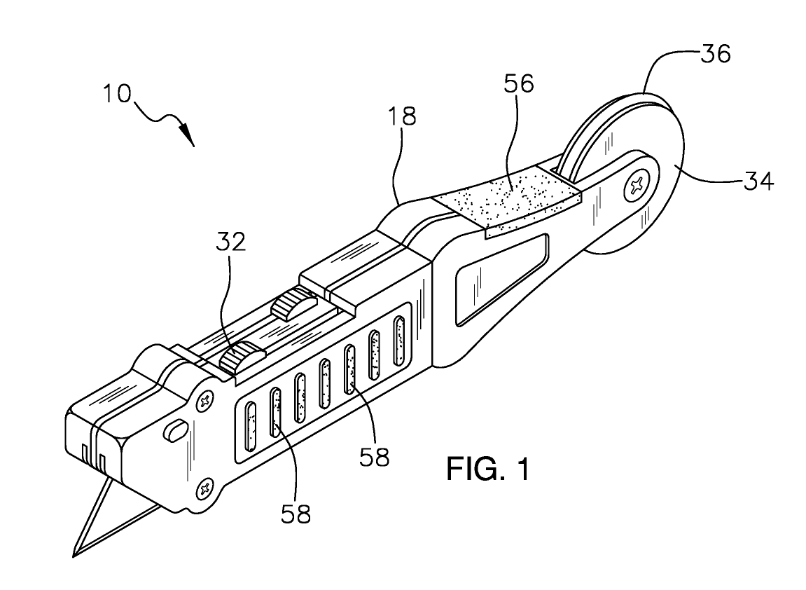

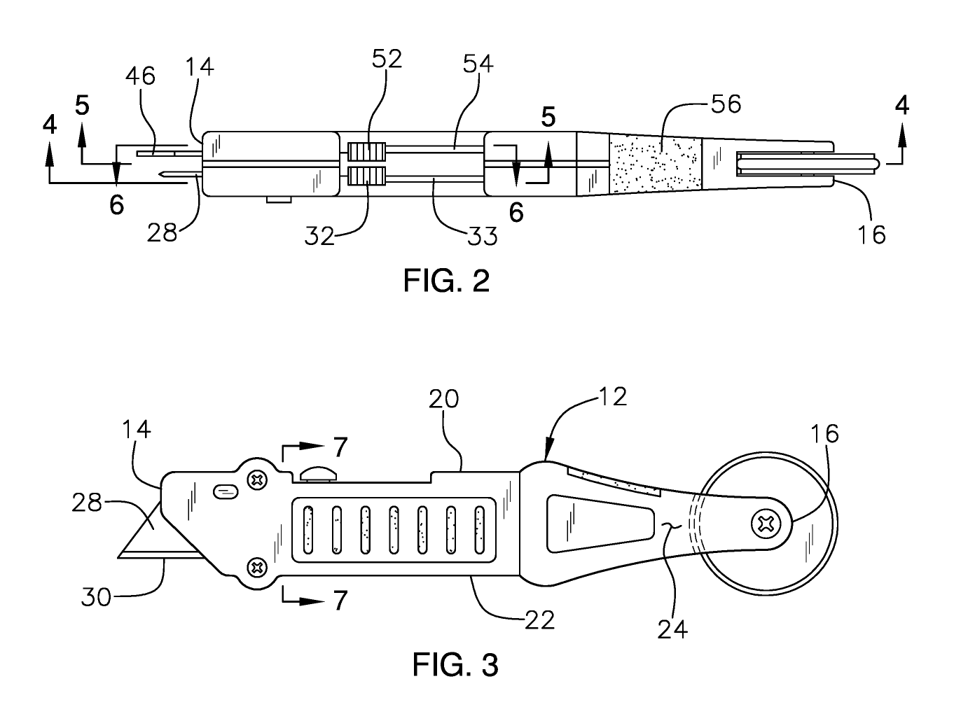

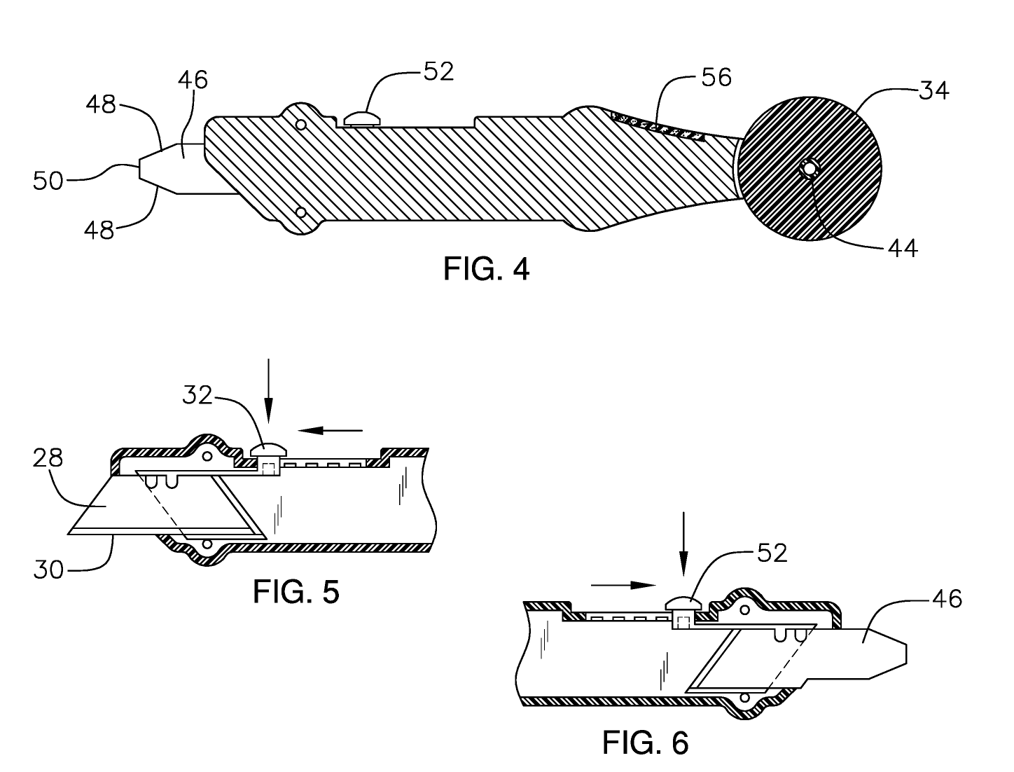

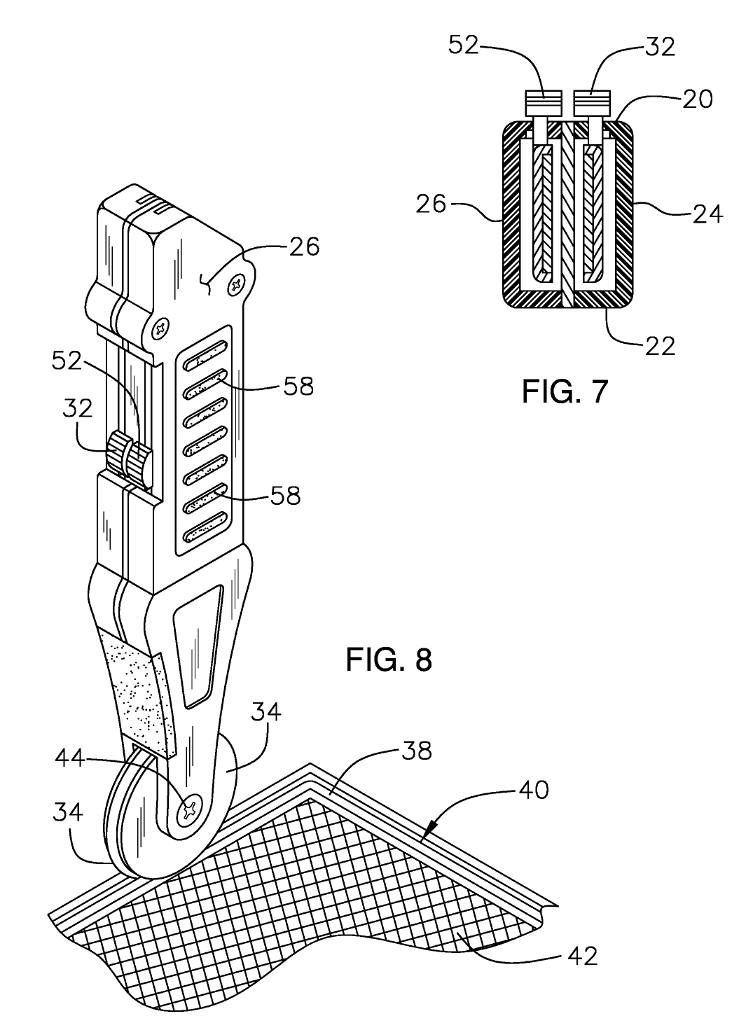

With reference now to the drawings, and in particular to FIGS. 1 through 10 thereof, a new spline positioning device embodying the principles and concepts of an embodiment of the disclosure and generally designated by the reference numeral 10 will be described.

As best illustrated in FIGS. 1 through 10, the screen and spline replacement tool 10 generally comprises an elongated housing 12 that has a first end 14, a second end 16 and a peripheral wall 18 extending between the first end 14 and the second end 16 to encompass and define an interior space. The peripheral wall 18 includes an upper wall 20, a lower wall 22, a first lateral wall 24 and a second lateral wall 26.

A blade 28 includes a sharpened edge 30. The blade 28 is coupled to the housing 12 and the blade 28 is selectively extendable from the interior of the housing 12 through the first end 14 of the housing 12. A first actuator 32 is operationally coupled to the blade 28 for selectively extending the blade 28. The first actuator 32 is positioned on the upper wall 20 of the housing 12. The first actuator 32 is positioned in a first slot 33 in the housing 12.

A wheel 34 is rotatably coupled to the housing 12. The wheel 34 has an outer perimeter edge 36 extending from the second end 16 of the housing 12 wherein the outer perimeter edge 36 is configured for urging screen spline 38 into a channel 40. The “spline” is typically an elongated elastomeric tube or cylinder that is pressed into the channel 40, surrounding a window opening, which also contains the edge of a screen material 42. The spline 38 is positioned on the screen material 42 to retain the screen material 42 in place. An axle 44 is coupled to the housing 12 and extends across the interior space of the housing 12 adjacent to the second end 16 of the housing 12. The axle 44 extends through a center of the wheel 34 such that the wheel 34 is rotatably mounted on the axle 44. The wheel 34 extends through the upper 20 and 22 lower walls. A distance between the upper 20 and lower 22 walls decreases from a central portion of the housing 12 to the second end 16 to facilitate exposing over 80% of the outer peripheral edge 36 of the wheel 34.

A prod 46 has a pair of flat edged angled sides 48 and a flat edged tip 50 extending between the angled sides 48. The prod 46 is configured for urging the screen spline 38 into a portion of the channel 40 adjacent to a corner. The prod 46 is selectively extendable from the interior of the housing 12 through the first end 14 of the housing 12. The blade 28 and the prod 46 are positioned in spaced, parallel planes with respect to each other. A second actuator 52 is operationally coupled to the prod 46 for selectively extending the prod 46. The second actuator 52 is positioned on the upper wall 20 of the housing 12. The second actuator 52 is positioned in a second slot 54 in the housing 12. The first 33 and second 54 slots are oriented parallel to each other.

A gripping pad 56 is positioned on the upper wall 20 adjacent to the second end 16. The gripping pad 56 may comprise an elastomeric material and will typically be used to support a user's thumb to allow sufficient force to be placed downwardly on the wheel 34. A plurality of gripping nubs 58 may be positioned on each of the first 24 and second 26 lateral walls. Each of the gripping nubs 58 is elongated along line oriented perpendicular to a longitudinal axis of the housing 12 extending through the first 14 and second 16 ends. The gripping pads 58 may be gripped by the user's fingers, particularly while using the blade 28, to prevent the user's hand from slipping along the housing 12 toward the blade 28.

In use, the blade 28 may be extended to cut screen material 42 as needed when replacing the screen material 42 in a screen door, screen window or the like. The wheel 34 is used to push screen spline 38 into place to hold the new screen material 42 in place. The prod 46 is selectively extendable to push the screen spline 40 into the corners of a screen frame 42.

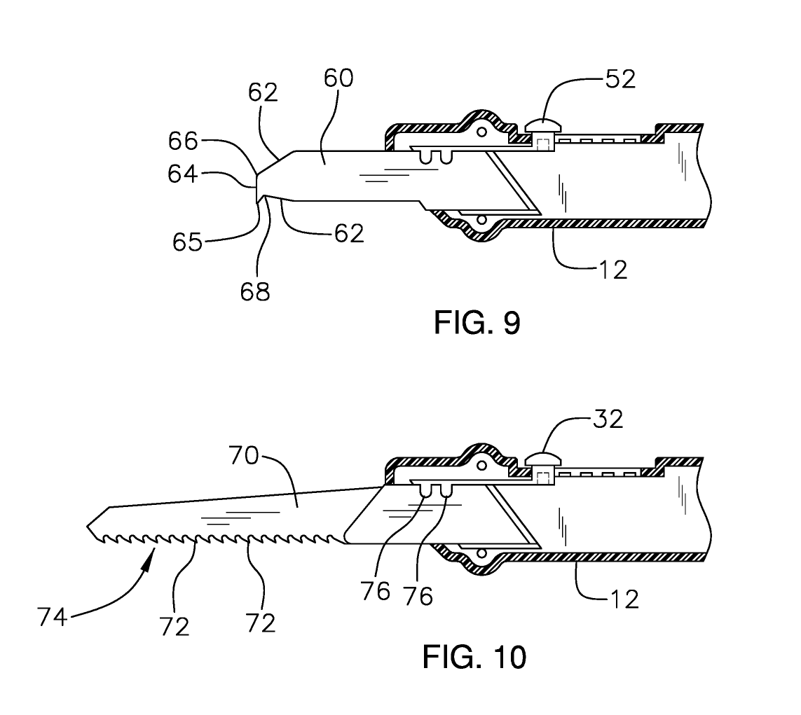

In FIG. 9, an alternative prod 60 is shown. The alternative prod 60 also has a pair of flat edged angled sides 62 and a flat edged tip 64. The flat edged tip 64 extends from an end 66 of one of the angled sides 62 and beyond an end 68 of another of the angled sides 62 forming a pick 65. The prod 60 is still configured for urging the screen spline 38 into a portion of the channel 40 adjacent to a corner. The pick 65 may facilitate this task as well as assist in snagging and withdrawing a portion of the spline 38 for repositioning when desired. The prod 60 is removably coupled to the housing 12 and may be provided as either an interchangeable alternative to prod 46 or simply as an alternative structure wherein prod 46 is structured as shown to include the pick 65. Thus, prod 60 is selectively extendable from the interior of the housing 12 through the first end 14 of the housing 12. The blade 28 and the prod 60 are positioned in spaced, parallel planes with respect to each other. The second actuator 52 is operationally coupled to the prod 60 for selectively extending the prod 60 in the same manner as prod 46 is operated.

In FIG. 10, a saw 70 is disclosed. The saw 70 has a plurality of spaced teeth 72 extending from a cutting edge 74 of the saw 70. The saw 70 further includes a pair of notches 76 used to removably couple the saw 70 to the housing 12 and the first actuator 32. The saw 70 is extendable from the housing 12 when needed or desired instead of the blade 28. It is contemplated that each of the blade 28, prod 46, prod 60, and saw 70 may be interchangeably coupled to the housing 12 such that the first actuator 32 and second actuator 52 may be used for each and the combination of blade 28, prod 46, prod 60, and saw 70 used with the housing 12 may be customized as desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A screen replacement device comprising:
an elongated housing having a first end, a second end and a peripheral wall extending between said first end and said second end defining an interior space, said peripheral wall including an upper wall, a lower wall, a first lateral wall and a second lateral wall;
a blade including a sharpened edge, said blade being coupled to said housing, said blade being selectively extendable from said interior of said housing through said first end of said housing;
a wheel being rotatably coupled to said housing, said wheel having an outer perimeter edge extending from said second end of said housing wherein said outer perimeter edge is configured for urging screen spline into a channel;
a first actuator operationally coupled to said blade for selectively extending said blade, said first actuator being positioned on said upper wall of said housing, said first actuator being positioned in a first slot in said housing; and
a prod, said prod having a pair of flat edged angled sides and a flat edged tip extending between said angled sides wherein said prod is configured for urging the screen spline into a portion of the channel adjacent to a corner, said prod being selectively extendable from said interior of said housing through said first end of said housing, said blade and said prod being positioned in spaced parallel planes.

2. The screen replacement device according to claim 1, further including an axle coupled to said housing, said axle extending across said interior space of said housing adjacent to said second end of said housing, said axle extending through a center of said wheel such that said wheel is rotatably mounted on said axle.

3. The screen replacement device according to claim 2, wherein said wheel extends through said upper and lower walls.

4. The screen replacement device according to claim 3, wherein a distance between said upper and lower walls decreasing from a central portion of said housing to said second end.

5. The screen replacement device according to claim 1, further including a second actuator operationally coupled to said prod for selectively extending said prod, said second actuator being positioned on said upper wall of said housing, said second actuator being positioned in a second slide button positioned in a second slot in said housing, said first and second slots being oriented parallel to each other.

6. The screen replacement device according to claim 1, further including a gripping pad being positioned on said upper wall adjacent to said second end, said gripping pad comprising an elastomeric material.

7. The screen replacement device according to claim 1, further including a plurality of gripping nubs being positioned on each of said and second lateral walls, each of said gripping nubs being elongated along line oriented perpendicular to a longitudinal axis of said housing extending through said first and second ends.

8. A screen replacement device comprising:
an elongated housing having a first end, a second end and a peripheral wall extending between said first end and said second end defining an interior space, said peripheral wall including an upper wall, a lower wall, a first lateral wall and a second lateral wall;
a blade including a sharpened edge, said blade being removably couplable to said housing, said blade being selectively extendable from said interior of said housing through said first end of said housing;
a wheel being rotatably coupled to said housing, said wheel having an outer perimeter edge extending from said second end of said housing wherein said outer perimeter edge is configured for urging screen spline into a channel, an axle coupled to said housing, said axle extending across said interior space of said housing adjacent to said second end of said housing, said axle extending through a center of said wheel such that said wheel is rotatably mounted on said axle, said wheel extending through said upper and lower walls, a distance between said upper and lower walls decreasing from a central portion of said housing to said second end;
a prod, said prod having a pair of flat edged angled sides and a flat edged tip extending between said angled sides wherein said prod is configured for urging the screen spline into a portion of the channel adjacent to a corner, said prod being selectively extendable from said interior of said housing through said first end of said housing, said blade and said prod being positioned in spaced parallel planes;
a saw, said saw having a plurality of spaced teeth extending along a cutting edge of said saw, said saw being removably couplable to said housing, said saw being selectively extendable from said interior of said housing through said first end of said housing, said saw being interchangeable with said blade for coupling to said housing;
a first actuator operationally coupled to said blade for selectively extending said blade, said first actuator being positioned on said upper wall of said housing, said first actuator being positioned in a first slot in said housing;
a second actuator operationally coupled to said prod for selectively extending said prod, said second actuator being positioned on said upper wall of said housing, said second actuator being positioned in a second slide button positioned in a second slot in said housing, said first and second slots being oriented parallel to each other;
a gripping pad being positioned on said upper wall adjacent to said second end, said gripping pad comprising an elastomeric material; and
a plurality of gripping nubs being positioned on each of said and second lateral walls, each of said gripping nubs being elongated along line oriented perpendicular to a longitudinal axis of said housing extending through said first and second ends.

9. The device of claim 8, further comprising said flat edged tip extending from an end of one of said angled sides and beyond an end of another of said angled sides forming a pick.
